(19) United States
(12) Patent Application Publication
(10) Pub. No.: US 2017/0200321 A1
(43) Pub. Date: Jul. 13, 2017

(54) Reputation Systems in Ride Share Platforms

(71) Applicant: Google Inc., Mountain View, CA (US)

(72) Inventors: Patrick Hummel, Cupertino, CA (US); Michael Schwarz, Berkley, CA (US); David Tao, Sunnyvale, CA (US)

(21) Appl. No.: 14/990,036

(22) Filed: Jan. 7, 2016

(51) Int. Cl. G07B 15/02; G06Q 50/32; G06Q 30/06

(52) U.S. Cl. CPC G07B 15/02; G06Q 30/0609; G06Q 30/0611; G06Q 50/32

(57) ABSTRACT

Systems and methods for implementing a ride share platform are provided. One example method includes obtaining a passenger reputation score associated with a passenger requesting a ride. The method includes determining a ride price for the requested ride based at least in part on the passenger reputation score. One example system includes one or more dispatch server computing devices that adjust a base compensation for a candidate driver to provide a ride to a passenger based at least in part on a driver reputation score. The example system communicates an offer to a mobile computing device operated by the candidate driver. The offer enables the candidate driver to assent to or decline to provide the ride to the passenger for the adjusted compensation. Another example system determines a priority order for offering candidate drivers based on value indices that have been adjusted according to candidate driver reputation.

### FIELD

The present disclosure relates generally to ride share platforms implemented by one or more computing devices and, more particularly, to reputation systems in ride share platforms.

### BACKGROUND

Ride share platforms can be used to coordinate rides for passengers with private drivers. More particularly, a driver that is or will be proximate to a passenger can be offered an opportunity to give the passenger a ride in exchange for some form of compensation or incentive. For instance, ride share platforms can receive requests from passengers for a ride between an origin and a destination during a given interval of time.

Ride share platforms can identify candidate drivers suitable for giving the passenger the requested ride. The ride share platforms can present offers to the identified drivers to give a ride to the passenger. The offers can include compensation for providing the ride to the passenger. The compensation can be determined based on various factors, such as physical distance or temporal length of the ride, auction bidding, or based on supply and demand.

When a driver accepts an offer, the passenger can be alerted that a ride has been arranged for the passenger. The ride share platform can navigate the candidate driver to the passenger location and along the travel route requested by the passenger.

Certain existing ride share platforms simply make offers to any candidate driver as soon as such candidate driver is recognized as available. For example, such systems may simply make an offer to the first identified candidate driver, and if multiple candidate drivers are identified, then such systems may simply make an offer to the identified candidate driver who is most proximate to the passenger.

Thus, such existing systems do not attempt to balance various other concerns which compete with maximizing the probability of providing the ride to the passenger. In particular, such systems typically do not consider or otherwise select the candidate driver based on a reputation of the candidate driver or a reputation of the passenger.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for operating a ride share network. The method includes receiving, by one or more computing devices, a request from a passenger for a ride from an origin to a destination. The method includes identifying, by the one or more computing devices, a candidate driver available to provide the ride to the passenger. The method includes obtaining, by the one or more computing devices, a passenger reputation score associated with the passenger. The method includes determining, by the one or more computing devices, a ride price for the ride from the origin to the destination based at least in part on the passenger reputation score.

Another example aspect of the present disclosure is directed to a computer system to operate a ride share network. The computer system includes one or more dispatch server computing devices communicatively coupleable to a plurality of mobile computing devices respectively operated by one or more candidate drivers and one or more passengers. The one or more dispatch server computing devices include one or more processors and one or more non-transitory computer-readable media that store instructions that, when executed by the one or more processors, cause the one or more dispatch server computing devices to receive a request from a passenger for a ride from an origin to a destination. Execution of the instructions further causes the one or more dispatch server computing devices to identify a candidate driver available to provide the ride to the passenger. Execution of the instructions further causes the one or more dispatch server computing devices to determine a base compensation for the candidate driver to provide the ride to the passenger. Execution of the instructions further causes the one or more dispatch server computing devices to obtain a driver reputation score associated with the candidate driver. Execution of the instructions further causes the one or more dispatch server computing devices to adjust the base compensation based at least in part on the driver reputation score to obtain an adjusted compensation. Execution of the instructions further causes the one or more dispatch server computing devices to communicate an offer to a mobile computing device operated by the candidate driver. The offer enables the candidate driver to assent to or decline to provide the ride to the passenger for the adjusted compensation.

Another example aspect of the present disclosure is directed to a computing system. The computing system includes one or more processors and one or more computer-readable media, the one or more computer-readable media storing computer-readable instructions that when executed by the one or more processors cause the one or more processors to receive a request from a passenger for a ride from an origin to a destination. Execution of the instructions further causes the one or more processors to identify a plurality of candidate drivers for providing the ride to the passenger. Execution of the instructions further causes the one or more processors to determine a plurality of value indices respectively for the plurality of candidate drivers. The plurality of value indices include a first value index for a first candidate driver of the plurality of candidate drivers. Execution of the instructions further causes the one or more processors to obtain a first driver reputation score for the first candidate driver of the plurality of candidate drivers. Execution of the instructions further causes the one or more processors to adjust the first value index determined for the first candidate driver based at least in part on the first driver reputation score to obtain an adjusted first value index. Execution of the instructions further causes the one or more processors to determine a priority order for the plurality of candidate drivers based at least in part on the plurality of value indices including the adjusted first value index. Execution of the instructions further causes the one or more processors to communicate an offer to provide the passenger a ride to at least one of the plurality of candidate drivers according to the priority order. The offer includes a compensation value for providing the ride to the passenger.

Other aspects of the present disclosure are directed to systems, apparatus, tangible non-transitory computer-readable media, memory devices, user interfaces and devices for implementing one or more aspects of a ride share platform.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

FIG. 1 depicts an example system for coordinating rides among drivers and passengers according to example embodiments of the present disclosure.

FIG. 2 depicts an example user interface presented on a passenger device according to example embodiments of the present disclosure.

FIG. 3 depicts an example user interface presented on a driver device according to example embodiments of the present disclosure.

FIG. 4 depicts a flow diagram of an example method for implementing a ride share platform according to example embodiments of the present disclosure.

FIG. 5 depicts a flow diagram of an example method for implementing a ride share platform according to example embodiments of the present disclosure.

FIG. 6 depicts a flow diagram of an example method for implementing a ride share platform according to example embodiments of the present disclosure.

FIG. 7 depicts a flow diagram of an example method for implementing a ride share platform according to example embodiments of the present disclosure.

FIG. 8 depicts a flow diagram of an example method for implementing a ride share platform according to example embodiments of the present disclosure.

FIG. 9 depicts a flow diagram of an example method for implementing a ride share platform according to example embodiments of the present disclosure.

FIG. 10 depicts an example computing system for implementing a ride share platform according to example embodiments of the present disclosure.

### DETAILED DESCRIPTION

### Overview

Generally, the present disclosure provides systems and methods for operating a ride share platform and network. In particular, the systems and methods of the present disclosure can measure a reputation of drivers and passengers and then use this measure of reputation to impact various parameters of the ride share network, including decisions regarding how much the passenger is required to pay if the passenger receives a ride; how much a driver will be compensated for providing the ride; and/or which drivers will be offered to provide the ride to the passenger and in what order.

As one example, when a passenger requests a ride, the systems and methods of the present disclosure can obtain a passenger reputation score associated with such passenger. The systems and methods of the present disclosure can then determine a ride price that a passenger must pay to receive the requested ride based at least in part on the passenger reputation score associated with the passenger. For example, the ride price can be increased for a passenger with a poor reputation. In such fashion, the passenger is required to compensate for the negative actions (e.g., last minute cancellations) that led to the passenger's poor reputation. In particular, the passenger can pay increased fares for several rides until she has repaid an amount roughly equal to the economic damage the passenger has caused by her undesirable actions.

As another example, when a candidate driver is identified as available to provide a ride to a passenger, a driver reputation score associated with such candidate driver can be obtained. The systems and methods of the present disclosure can then adjust a base compensation for the candidate driver based at least in part on a driver reputation score associated with such candidate driver. For example, the offered compensation can be reduced for a candidate driver with a poor reputation. In such fashion, the candidate driver is required to compensate for the negative actions (e.g., late pickups) that led to the candidate driver's poor reputation. In particular, the driver can receive reduced compensation over several rides until she has compensated an amount roughly equal to the economic damage the driver has caused by her undesirable actions.

In yet another example, in addition or alternatively to use of the driver reputation score to adjust the compensation offered to the candidate driver, the candidate driver's reputation score can be used to impact a likelihood that the candidate driver will be offered an opportunity to provide the passenger the ride. For example, in some implementations of the present disclosure, offers to provide the passenger the ride can be transmitted to candidate drivers according to a priority order. As such, in some implementations of the present disclosure, a candidate driver's reputation score can impact such candidate driver's position relative to other drivers within the priority order. For example, candidate drivers with poor reputations can be relegated to a lower position within the priority order. Thus, in addition or alternatively to receiving reduced compensation, the driver can compensate for her undesirable actions through a reduced probability of being offered potentially profitable driving opportunities.

Thus, the present disclosure provides techniques for matching passengers to drivers and for setting prices for rides which take the respective passenger and driver reputation scores into account. In addition, the present disclosure provides rules for measuring how much a user should be penalized as a result of various transgressions the user has committed and for adjusting a user's reputation over time as a result of various actions. Finally, the present disclosure provides techniques for communicating to a user that the user is being penalized for transgressions.

More particularly, two separate reputation scores can be maintained for each user of the ride share platform. In particular, a passenger reputation score and a driver reputation score measure a user's reputation as a passenger and a driver, respectively. This formulation allows for the possibility that a user could have a good reputation as a passenger but a poor reputation as a driver (or vice versa). For example, a user might have certain qualities that makes the user a poor driver (such as a car that is not clean) even though the user is still perfectly reliable as a passenger. In other implementations, the two reputation scores can be linked or otherwise impact each other in some fashion.

In some implementations of the present disclosure, a larger driver or passenger reputation score corresponds to a poorer reputation, while smaller or even negative reputation scores correspond to more highly regarded reputations. Thus, in such implementations, a positively valued reputation score can be viewed as an amount of poor reputation for which a user must compensate to return to a normal or baseline reputation. The above described system of positive and negative scores is solely a matter of convention, and can easily be inverted while remaining within the scope of the present disclosure.

In some implementations, all users initially have a passenger reputation score and a driver reputation score equal to zero. Thereafter, the user's reputation score(s) are modified as a result of various actions, inactions, feedback, or other data regarding user behavior and system participation.

More particularly, according to an aspect of the present disclosure, a user's passenger reputation score and/or driver reputation score can be modified over time in response to certain actions taken (or not taken) by the user. As one example, a user's driver and/or passenger reputation score can be adjusted (e.g., penalized) if the user cancels a previously scheduled ride, thereby undesirably forcing the other party to the ride to change their plans and make alternative arrangements.

In some implementations, the amount by which a user's passenger and/or driver reputation score is modified can be proportional to the amount of economic harm that a user caused other users as a result of certain transgressions. As an example, if a driver cancels a ride far in advance of when the ride is scheduled to take place, then only a modest penalty might be imposed on the driver for this cancellation, since the passenger will still have plenty of time to find alternative transportation and the passenger thus does not suffer all that much harm. However, if a driver cancels a ride just before the ride is supposed to take place, a much larger penalty might be imposed to reflect the fact that the passenger is now without transportation and will have difficulty finding alternative transportation on a short notice, so the passenger will suffer significant economic harm.

Thus, in general, whenever a user cancels a ride, the user's driver or passenger reputation score (whichever the case may be) can be adjusted (e.g., increased or otherwise penalized) by an amount that is non-increasing in the amount of time in advance of the ride in which this cancellation took place, thereby causing the penalty to be roughly proportional to an amount of economic harm caused by the cancellation. For example, the user's driver or passenger reputation score (whichever the case may be) can be adjusted (e.g., increased or otherwise penalized) by an amount that is inversely proportional to an amount of time in advance the cancellation took place. As used herein, the term “inversely proportional” does not necessarily require a strict linear relationship between parameters but instead describes a general relationship in which a first parameter increases when a second parameter decreases, and vice versa.

Additional actions, feedback, or other data can also affect a user's driver and/or passenger score, in addition to ride cancellations. As an example, after a ride takes place, the participating users may be asked feedback questions that could influence the reputation of the other participating user(s). As examples, these questions may include questions such as whether the ride took place; whether the carpool partner was polite and considerate; whether the inside of the car was clean; whether the experience was a good one; whether the user would consider sharing a ride with this person again; and whether the other carpooler was on time.

The ride share platform can then impose reputation score penalties (e.g., increases in reputation score) and/or score rewards (e.g., decreases in reputation scores) on the basis of the answers to these feedback questions. For instance, a penalty can be imposed on a reputation score for not being polite and considerate or for a ride not taking place without a cancellation. As another example, a user's driver reputation score might be penalized if the passenger indicates that the inside of the driver's car was not reasonably clean or if the driver was late to the pick up the passenger.

Again, the amount by which the user's reputation score is adjusted can be proportional to the amount of economic harm that resulted from the indicated transgressions. For instance, a user's driver reputation score can be adjusted by a relatively smaller amount for being two minutes late while the user's driver reputation score can be adjusted by a relatively larger amount for being ten minutes late. Likewise, a user's driver reputation score can be adjusted by a relatively smaller amount if the passenger feedback indicates that the driver's vehicle was relatively unclean (e.g., rated 3 out of 5), while the user's driver reputation score can be adjusted by a relatively larger amount if the passenger feedback indicates that the driver's vehicle was very unclean (e.g., rated 1 out of 5 stars).

The ride share platform can also adjust a user's passenger or driver reputation score based on items other than bad or undesirable actions. For example, in some implementations, a user may also be enabled to improve her reputation score (e.g., decrease her reputation score) as a result of performing various good or desired actions or simply through participating in the ride share system without performing undesirable actions as described above (e.g., canceling a ride).

In one example, the ride share platform can implement gradual decreases in a user's driver and/or passenger reputation score for good behavior. For instance, a user's driver and/or passenger reputation score might be decreased by a reputation score deflator for every fixed time period (e.g., hour, day, etc.) where the user does not incur a penalty, even if the user did not use the ride share platform during such time period. As one example, application of the reputation score deflator can cause the user's reputation score to be reduced by a certain percentage. As one particular example, the reputation score deflator can equal 99 percent, such that application of the reputation score deflator to a user's reputation score causes the user's reputation score to be reduced by 1 percent. In other implementations, the reputation score deflator can be a fixed amount, rather than a percentage.

Use of a reputation score deflator in such fashion means that even a user with a very poor reputation (e.g., a very large reputation score) is eventually able to reduce her reputation score after an extended period of good behavior. Thus, in some implementations in which a user with a reputation score that exceeds an acceptable amount is excluded from use of ride share platform, such a user may be able to lower her score and then begin using the ride share platform again after a “timeout.” However, it could potentially take a user a relatively long time to pay off her reputation score in this way.

As another example, in some implementations, a user is able to earn one or more reputation rewards every time the user completes a ride (e.g., as either a passenger or a driver) without an adverse incident. Each reward may represent a reduction (in some implementations to the point of going negative) in a user's driver and/or passenger reputation score, depending on whether the user completed the ride as a driver or a passenger.

Thus, as an example, if a user shows good behavior in using the ride share platform for an extended period of time, but the user then has one incident in which the user is accidentally a few minutes late, then the user may be able to avoid having a positive reputation score because the reputation rewards the user earned from the extended period of good behavior sufficiently offset the reputation penalty resulting from this one bad incident.

However, in some implementations, a bound on the maximum number of reputation rewards that a user can accumulate can be imposed. Use of such a bound prevents a user from accumulating so many reputation rewards that the user would be able to effectively get away with several consecutive bad actions. In some implementations, instead of a bound on the maximum number of reputation rewards that a user can accumulate through incident-free rides, a user's driver and/or passenger reputation score may simply be capped at a certain negative number (e.g., cannot be more negative than such certain negative number).

Primarily, however, a user can reduce their reputation score (e.g., compensate for past undesirable actions) by completing a ride without incident in which the user received a less favorable price and/or ranking for that ride request than the user would have if the user did not have a positive reputation score.

In particular, a passenger may be able to significantly decrease her passenger reputation score if the passenger pays more for a ride than the passenger would have in the absence of a positive reputation score. As one example, if a ride would have cost the passenger $8 if the passenger had a reputation score of zero (or even a negative score), but the ride costs the passenger $10 as a result of the user's positive passenger reputation score, then the passenger will pay off $2's worth of the passenger reputation score by paying a higher price for this ride.

Similarly, a driver can decrease his driver reputation score if the driver is compensated less for providing a ride than the driver would have been compensated in the absence of a positive driver reputation score. Again, the user's driver reputation score can be reduced by an amount proportional to the decreased compensation the driver received for the ride due to the fact that the driver had a positive driver reputation score. In another example, a user's driver reputation score can be decreased if, as a result of the user's driver reputation score, the user is ranked less highly for receiving an offer to provide a ride but is still matched with a passenger and completes the ride without incident.

More particularly, some example ride share platforms of the present disclosure can match passengers to drivers and set prices for rides by generating a set of candidate drivers who could possibly give a passenger a ride. A value index is then computed for each of these candidate drivers. The value index for each candidate driver can reflect a total amount of economic surplus that would be generated if that driver gave the passenger the requested ride. In some implementations, this value index will take into account, amongst other things, the amount the passenger is willing to pay for a ride (e.g., as reflected by a passenger's bid) and the cost to the candidate driver from picking up the passenger as reflected by, amongst other things, the length of the detour the driver would have to make to pick up the passenger.

In some implementations, the compensation provided to the driver for providing the ride is equal to an estimate of how much it would cost the driver to pick up the passenger. In other implementations, an expected second-price pricing system is used to determine driver compensation. In the expected second-price pricing system, the compensation a driver is provided for a ride is based on the expected amount it would cost the other candidate drivers (e.g., the next ranked candidate driver) to pick up the passenger.

However, according to aspects of the present disclosure, if a user has a positive reputation score d, then the ride share platform can enable a user to “pay off” some fraction r (e.g., r=¼) of her reputation score by adjusting the algorithm for matching passengers to drivers and/or setting prices for rides to take the user's reputation score into account. In some implementations, the fraction r can be denominated as a score adjustment rate.

As one example, if a passenger has a positive passenger reputation score of d, a base price determined by the system for a ride requested by the passenger can be increased by an amount rd, where r corresponds to the passenger score adjustment rate. In some implementations, the base price can be determined based at least in part on an estimate of the cost that a candidate driver would have to incur in order to give this passenger a ride (e.g., by making a detour from the driver's anticipated route).

In the above example, if a passenger receives a ride from a given driver, then the passenger will have to pay an amount rd more for this ride than the passenger would have had to pay in the absence of the passenger having a positive passenger reputation score. Thus, the amount of the passenger reputation score the passenger “pays off” equals the extra payment the passenger had to make for a ride.

In addition, in some implementations of the present disclosure, the ride share platform matches a passenger with a driver only when the passenger bids more for a ride than the estimated cost required for the driver to provide the ride. In such implementations, for any fixed bid that a passenger with a positive passenger reputation score makes for a ride request, the passenger is less likely to be matched with a driver than the passenger would have been if the passenger did not have a positive passenger reputation score. However, a passenger can still achieve the same probability of receiving a ride by bidding an amount rd more for the ride when the passenger is trying to pay off a positive passenger reputation score of d.

According to another aspect of the present disclosure, if a driver has a positive driver reputation score of d, the driver can pay off a fraction r of this reputation score according to at least two approaches. Under a first approach, the ride share platform ranks the driver in the same way that he would be ranked absent a positive driver reputation score. However, the compensation offered to the driver for providing the ride (assuming the driver is in fact offered to provide the ride at all) would be reduced by an amount rd. Thus, the driver would be able to reduce his driver reputation score by an amount rd if the driver accepts rd less compensation for giving the passenger the ride than he would receive normally.

In some implementations of the present disclosure which implement this first approach, the ride share platform can ensure that a driver never receives an offer that is inappropriately low, as an offer to a candidate driver which is inappropriately low may insult the driver or otherwise degrade the driver's interaction with the ride share platform. In one example, the ride share platform may simply decline to make an offer to a driver any time the amount of compensation that would be offered the driver is too low (e.g., is below a threshold amount or a threshold percentage of a base compensation).

In another example, if the amount of compensation that would be offered the driver is too low, the ride share platform may simply reduce the driver's compensation and reputation score by a relatively smaller amount than the initially proposed amount rd. More particularly, if a base compensation p denotes the compensation that the ride share platform would offer the driver if the driver had a zero or negative driver reputation score and c denotes a minimum amount that would be an acceptable offer to make to the driver, then the ride share platform can offer the driver compensation equal to the larger of c and p-rd. However, in such instances, the ride share platform will only reduce the driver's reputation score by p-c if the driver is compensated the amount c for the ride. Likewise, the ride share platform will reduce the driver's reputation score by rd only if the driver is compensated the amount p-rd for providing the ride. Thus, the amount by which the driver reputation score is reduced is equal to the amount by which the driver's compensation was reduced from the base compensation.

In a second approach to reducing driver reputation scores, the ride share platform does not change the amount of compensation that a driver is offered for giving a passenger a ride. Instead, the ride share platform decreases the estimated value index used for the driver when ranking available candidate drivers. Thus, the driver's ranking among candidate drivers available to provide the ride to the passenger can potentially be reduced or otherwise hampered in exchange for the driver's reputation score being reduced.

More particularly, in some of the above described implementations, if a driver is paying off an amount rd of his driver reputation score, then the ride share platform also decreases the driver's value index by the amount rd. As a result, the driver may be ranked lower amongst the set of candidate drivers, thus decreasing the probability that the driver will be offered the option of giving the passenger a ride. Thus, the penalty the driver pays for a positive driver reputation score comes from the driver's reduced probability of being offered potentially profitable opportunities to give rides to passengers.

Further, in some implementations, the driver's reputation score is only reduced by the amount rd in the event that, after the driver's value index was penalized by the amount rd in ranking the driver, the driver is actually offered and completes the ride request without incident. Thus, in such implementations, the driver reputation score is not reduced for each instance in which the driver's value index is reduced. Instead, the driver's reputation score is only reduced when the driver's value index is reduced but the driver is still offered and completes the ride without incident.

In further implementations of the present disclosure, ride share platforms may employ combinations of the two approaches described above. That is, the ride share platform can both decrease the amount of compensation that is offered to a driver for providing a ride and decrease this driver's ranking amongst the candidate drivers when the driver has a positive driver reputation score.

According to another aspect, the present disclosure provides techniques for communicating to a user that the user is being penalized for transgressions. As one example, any time a user attempts to cancel a ride, the ride share platform can first notify the user that canceling the ride may make it more difficult for the user to find rides in the future. Providing such communication ensures that a user will realize that taking an undesirable action has real consequences that will hurt the user in the future.

As another example, in some implementations of the present disclosure, the ride share platform suggests bids that a passenger can make for a ride. The suggested bids are designed in such a way to ensure that the passenger will have a high probability of finding a ride if the passenger in fact bids an amount equal to the suggested bid. As such, the reputation of the passenger can be taken into account when the ride share platform makes suggested bids, such that higher bids are suggested if the passenger has a positive passenger reputation score, as higher bids are now necessary in order for the passenger to have the same probability of finding a ride as before. If a passenger has recently taken an action that resulted in penalization of the passenger's reputation score, the passenger will notice that the suggested bids are higher than they were before. The passenger will take note of such higher suggested bids and realize that he or she has to pay more for rides after an undesirable action.

As yet another example, since a driver with a positive reputation score will receive lower compensation for rides and/or will be less likely to receive ride requests, the driver will also notice that he suffers a penalty as a result of his poor reputation.

Thus, aspects of the present disclosure have the technical effect of using a measure of the reputation of drivers and passengers both to rank the drivers in a priority order by which they will be offered the opportunity to give the passenger a ride; to determine how much the driver will be compensated for providing the ride; and/or to determine how much the passenger should have to pay for the ride if the passenger receives a ride.

In particular, one benefit of the example aspects of the present disclosure is ensuring that the penalty that a user pays for a bad action such as canceling a ride is closely tied to the amount of harm the user caused as a result of this bad action, thus giving the user an incentive to take into account the exact economic harm he or she will cause another party as a result of taking a bad action.

Another benefit of example aspects of the present disclosure is ensuring that users who are consistently bad actors are effectively excluded from using the platform because such users would have such large reputation scores that the system would effectively never be able to find a match for that user at a reasonable price.

As yet another benefit, the systems and methods of the present disclosure appropriately communicate that users will be penalized if they take bad actions by, for example, informing a user that cancelling a ride will make it more difficult for them to find good rides in the future.

Furthermore, in some implementations of the present disclosure, a user may not receive the benefits or be included in the techniques described herein unless they select a setting and/or install one or more applications, drivers, etc. In some implementations, certain data can be treated in one or more ways before it is stored or used, so that user information and/or geographic information is removed.

With reference now to the Figures, example embodiments of the present disclosure will now be discussed in further detail.

### Example Ride Share Platforms

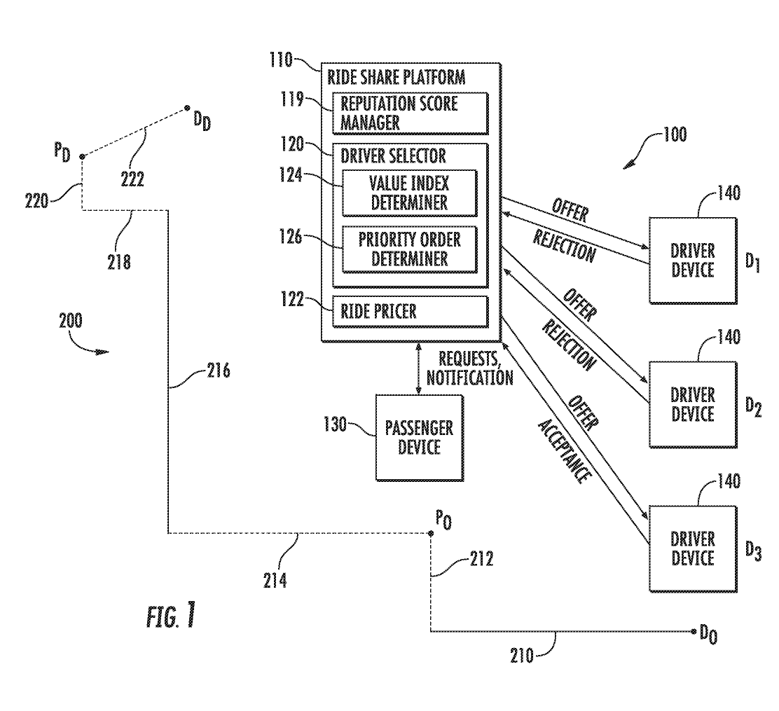

FIG. 1 depicts an example system 100 for coordinating rides among passengers and drivers according to example embodiments of the present disclosure. The system 100 includes a ride share platform 110. The ride share platform 110 can be implemented by one or more computing devices. In one example implementation, the ride share platform 110 can be implemented by the one or more dispatch server computing devices of FIG. 10 and configured to communicate with one or more mobile computing devices over a network.

The ride share platform 110 can communicate with a passenger device 130 associated with a passenger and one or more driver devices 140 associated with one or more candidate drivers. The passenger device 130 and the one or more driver devices 140 can be any suitable computing device, such as a smartphone, tablet, laptop, PDA, mobile phone, navigational device, navigational component embedded within a vehicle, autonomous vehicle computing system, wearable computing device, or other computing device.

In particular, as used herein, the term “candidate driver” includes any form of transportation capable of providing a requested ride to a passenger. Thus, a candidate driver can include a humanly operated vehicle (e.g., traditional human driver and car) or an autonomous vehicle (e.g., “self-driving” car).

As will be discussed in more detail below, a passenger can provide a request via passenger device 130 to the ride share platform 110 for a ride from an origin to a destination. The request can be manually specified by the passenger using a suitable user interface or can be automatically generated, for example, based on historical data indicative of previous ride requests associated with the passenger.

The ride share platform 110 can identify candidate drivers for providing the passenger the ride and can communicate an offer to one or more candidate drivers via a driver device 140 to provide the passenger a ride. The candidate driver can send notification of acceptance or rejection of the offer to the ride share platform 110.

More particularly, a passenger can generate a request for a ride using a suitable user interface presented on, for example, a display of the passenger device 130. The request can include an origin, a destination, a pickup window of time when the passenger needs to be picked up, an arrival window of time when the passenger needs to reach the destination, the amount of time the passenger can wait before learning if a ride is available, a maximum bid, and/or other information. The request can be communicated to the ride share platform from the passenger device 130, for example, over a network.

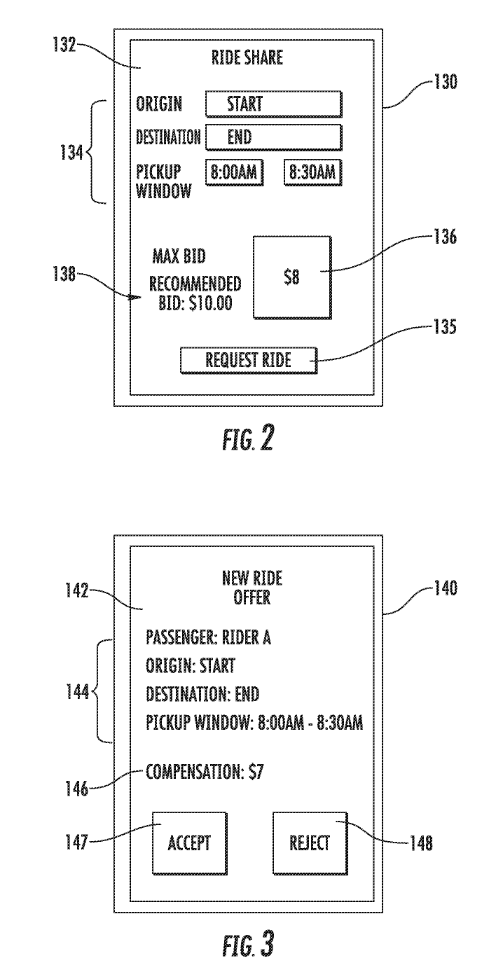

FIG. 2 depicts an example user interface 132 presented on a display of a passenger device 130 according to example embodiments of the present disclosure. The user interface 132 allows a user to generate a request for a ride. The user interface 132 includes a plurality of fields 134 that allow a user to specify information and/or parameters for the request, such as an origin, destination, and pickup window.

The user interface 132 further includes a bidding field 136 where the passenger can specify a maximum bid for the request. The maximum bid can be set to any desired value. Higher maximum bids can result in an increased probability of obtaining a ride using the ride share platform. By submitting the maximum bid, the passenger agrees to pay an amount at least as great as the maximum bid for the ride.

In some implementations, the user interface 132 can present a suggested or recommend maximum bid 138. The recommended maximum bid 138 can be generated by the ride share platform 110 of FIG. 1 and communicated to the passenger device 130 for display in the user interface 132. The recommended maximum bid 138 can be determined using a variety of factors, such as length of the ride, cost of pick up, length of departure window, probability of finding a match, etc.

In one example implementation, the recommended maximum bid 138 can be determined as a non-linear function of distance associated with the ride. As one particular example, the recommended maximum bid 138 can be determined as a function of a fixed cost for picking up the candidate driver (e.g., $4.00) plus a fixed cost for the first mile (e.g., $1.00) and a per mile cost that is decreasing with mileage to a lower cost per mile (e.g., $0.25). The length of the pickup window specified by the passenger can also be a factor in determining the recommended maximum bid 138. For instance, narrower pickup windows can result in higher recommended maximum bids as a result of the ride share platform providing higher compensation for rides with narrower pickup windows. In other example implementations, historical data associated with the ride share platform 110 can be used to estimate a probability of finding a match for any maximum bid for a particular route. The recommended maximum bid 138 can be set such that a passenger meets a threshold probability (e.g., 95%) for obtaining a ride.

Referring to FIG. 2, once the passenger has specified the maximum bid in the maximum bid field 136, the passenger can send the request to the ride share platform 110 by interacting with the request ride interface element 135. In one example, the request can specify a ride from a passenger origin P_{O} to a passenger destination P_{D}. The request can then be communicated to the ride share platform 110 as shown in FIG. 1. The ride share platform 110 can then process the request to coordinate a ride for the passenger.

Referring again to FIG. 1, the ride share platform 110 can include a reputation score manager 119, a driver selector 120, and a ride pricer 122. The driver selector 120 can include a value index determiner 124 and a priority order determiner 126.

Each of the reputation score manager 119, driver selector 120, the ride pricer 122, the value index determiner 124 and the priority order determiner 126 include computer logic utilized to provide desired functionality. Each of the reputation score manager 119, driver selector 120, the ride pricer 122, the value index determiner 124 and the priority order determiner 126 can be implemented in hardware, firmware, and/or software controlling a general purpose processor. For example, in some implementations, each of the reputation score manager 119, driver selector 120, the ride pricer 122, the value index determiner 124 and the priority order determiner 126 are program files stored on a storage device, loaded into a memory and executed by one or more processors. In other implementations, each of the reputation score manager 119, driver selector 120, the ride pricer 122, the value index determiner 124 and the priority order determiner 126 are sets of computer-executable instructions that are stored in a tangible computer-readable storage medium such as RAM hard disk or optical or magnetic media.

The ride share platform 110 can implement the reputation score manager 119 to manage reputation scores for users of the ride share platform 110. In particular, in some implementations, the reputation score manager 119 can maintain (e.g., as data stored in a database) both a passenger reputation score and a driver reputation score for each user of the ride share platform 110. In other implementations, a single reputation score is maintained for each user.

The reputation score manager 119 can adjust a user's reputation score(s) based on the user's actions, the user's inactions, feedback regarding the user, or other data describing the user's interactions with the ride share platform. In particular, the reputation score manager 119 can be configured to apply a map between certain user actions (e.g., undesirable actions) and respective values by which reputation scores are adjusted as a result of such respective user actions. For example, undesirable actions result in a user's passenger or driver reputation score (whichever the case may be) being increased by the respective adjustment value associated with such action. In addition, in some implementations, the value associated with each action is proportional to an economic impact associated with such action. Thus, for example, in response to a user committing an undesirable action which has a larger negative impact, the reputation score manager 119 can increase the user's passenger or driver reputation score by a relatively larger value.

The reputation score manager 119 can also reduce a user's passenger or driver reputation score as a result of various occurrences. In one example, if a passenger completes a ride in which her price was increased, then the reputation score manager 119 can decrease the user's passenger reputation score by a corresponding amount. Likewise, if a driver completes a ride in which his compensation was decreased, then the reputation score manager 119 can decrease the user's driver reputation score by a corresponding amount. In another example, if a driver completes a ride in which he was ranked lower in an offer priority order, then reputation score manager 119 can decrease the user's driver reputation score by an amount that corresponds to the amount by which the driver was penalized in such ranking.

In yet another example, the reputation score manager 119 can periodically apply a reputation score deflator. Through periodic application of the reputation score deflator, the reputation score manager 119 can slowly reduce (e.g., at a rate of 1 percent per day) a user's reputation scores, even if the user does not participate in the ride share platform during the period.

Additional details regarding particular techniques that are implementable by the reputation score manager 119 are discussed in more detail in the Overview section above and also with respect to FIGS. 4-9 below.

Referring again to FIG. 1, the ride share platform 110 can implement the driver selector 120 to identify one or more candidate drivers that are available to provide the passenger the requested ride; determine a value index for each identified candidate driver; determine a threshold value for each identified candidate driver; and compare the value index for each candidate driver to the respective threshold value. The driver selector 120 and ride pricer 122 can cooperatively operate to generate an offer for a candidate driver to provide a ride to the passenger.

More particularly, the driver selector 120 can identify one or more candidate drivers based on various criteria. As examples, information such as travel patterns associated with drivers, driver cost, maximum bid specified by the passenger, driver ratings, and other information can be used to identify the one or more candidate drivers.

In one particular implementation, the driver selector 120 can identify the one or more candidate drivers based at least in part on data indicative of travel patterns of drivers. For instance, data indicative of travel patterns can provide, for a particular driver, a typical travel route for the driver during a given time window. The data indicative of travel patterns can be manually input by drivers (e.g., by requesting navigational instructions from a maps application at the time of identification) and/or can be determined using historical location data or other data (e.g., travel direction search history) associated with drivers. For instance, historical data associated with a driver can be analyzed to determine a predicted travel path for the driver during a time window. More particularly, historical data can indicate that an individual typically travels from his home to work along a particular travel route during a particular travel window. Such individual can be identified as a candidate driver based on the predicted travel path.

According to an aspect of the present disclosure, the driver selector 120 can implement the value index determiner 124 to determine a value index for each identified candidate driver. The value index determined for a candidate driver is indicative of an amount of economic surplus that would be generated if the candidate driver provided the requested ride to the passenger. The value index determiner 124 can determine the value index for each driver based on various factors such as, for example, a driver cost and a passenger benefit. For example, the value index for a candidate driver can equal the passenger benefit minus the driver cost.

The value index determiner 124 can estimate a driver cost for each candidate driver. Generally, the driver cost is indicative of the cost of time and inconvenience for giving a ride to a passenger (e.g., the cost of detour to pick up and drop off the passenger). In some implementations, the driver cost can equal some minimum fixed cost plus a length of the trip or detour in miles and/or length of the trip or detour in minutes.

The value index determiner 124 can determine the passenger benefit, for example, based at least in part on the maximum bid specified by the passenger. In some implementations, the passenger benefit can be determined as a function of the maximum bid and the driver reputation score of the candidate driver.

As one example, driver D₃ can have an expected travel pattern from a driver origin D_{O} to a driver destination D_{D}. The expected travel pattern can be along travel route 200 depicted in FIG. 1. For driver D₃ to give the passenger a ride from the passenger origin P_{O} to the passenger destination P_{D}, the candidate driver D₃ will have to take a detour along segments 212, 214, 218, 220, and 222 of the travel route 200. Segments 210 and 216 of the travel route 200 can be segments that the candidate driver D₃ would have traversed regardless of providing the passenger a ride when traveling from the candidate driver origin D_{O} to the candidate driver destination D_{D}.

The candidate driver cost can be determined based at least in part on the travel distance and/or expected travel time associated with the detour segments 212, 214, 218, 220, and 222. In some implementations, if the candidate driver cost associated with driver D₃ is less than a passenger benefit, the candidate driver D₃ can be identified as a candidate driver. Thus, in such implementations, if the candidate driver cost associated with driver D₃ exceeds the passenger benefit, the candidate driver D₃ can be excluded from the set of identified candidate drivers that are available to provide the ride to the passenger. However, in other implementations, drivers can be identified as candidate drivers even when the driver cost exceeds the passenger benefit.

The ride share platform 110 can allow the passenger to specify criteria for drivers for use by the driver selector 120 in identifying one or more candidate drivers. For example, the passenger can request to be matched only with drivers of the same gender as the passenger. As another example, the passenger and/or driver can also specify preferred ride share partners. As yet another example, the passenger can request to be matched only with drivers having a driver reputation score below a certain threshold. As yet another example, the passenger can request to be matched only with drivers that are in the same age group as the passenger. Various other criteria can be specified by the passengers to be used by the driver selector 120 in identifying one or more candidate drivers.

According to another aspect of the present disclosure, the driver selector 120 can determine a threshold value for each identified candidate driver. The threshold value may be constant or may be determined according to various algorithms which balance the concerns of maximizing the generated surplus while ensuring that the passenger is provided a ride.

The driver selector 120 can compare the value index determined for a candidate driver to the threshold value determined for the candidate driver. The driver selector 120 can determine whether to communicate an offer to the candidate driver to provide the ride to the passenger based on such comparison. For example, in some implementations, the driver selector 120 will communicate an offer only if the candidate driver's value index exceeds the threshold value. The matched candidate driver can accept the offer or can reject the offer and communicate such acceptance or rejection to the ride share platform 110, for example, over a network.

According to yet another aspect of the present disclosure, the ride share platform 110 can implement the priority order determiner 126 to rank or prioritize the identified candidate drivers into a priority order. In particular example implementations of the present disclosure, the priority order can rank or prioritize drivers based at least in part on the value index associated with each candidate driver, as determined by the value index determiner 124.

As an example, the candidate driver with the highest value index can be ranked highest in the priority order. Referring to the example of FIG. 1, the driver selector 120 can identify drivers D1, D2, and D3 as candidate drivers. The value index determiner can determine a value index for each of the drivers D1, D2, and D3. The priority order determiner 126 can determine a priority order for the candidate drivers based on the value index associated with each candidate driver. The priority order can rank the candidate drivers such that D1 has the highest priority, D2 has the next highest priority, and D3 has the lowest priority.

The ride share platform 110 can be configured to present offers to the candidate drivers in accordance with the priority order. For instance, the candidate driver ranked highest in the priority order can be selected as a matched driver. The ride share platform 110 can communicate an offer only to the matched driver for providing the passenger a ride. The matched driver can accept the offer or can reject the offer and communicate such acceptance or rejection to the ride share platform 110, for instance, over a network.

According to another aspect of the present disclosure, in some implementations, the priority order determiner 126 can take candidate drivers' driver reputation scores into account when determining the priority order. For example, the priority order determiner 126 can adjust (e.g., reduce) the value index for a candidate driver that has a positive driver reputation score by some amount that is reflective of the magnitude of the driver's reputation score. After adjusting the value indices of the candidate drivers according to driver reputation scores, the candidate drivers can be ranked or re-ranked in the priority order.

More particularly, as one example, if a driver is paying off an amount rd of reputation score, then the priority order determiner 126 also decreases the driver's value index by the amount rd. As a result, the driver may be ranked lower amongst the set of candidate drivers within the priority order, thus decreasing the probability that the driver will be offered the option of giving the passenger a ride. Thus, the penalty the driver pays for a positive driver reputation score comes from the driver's reduced probability of being offered potentially profitable opportunities to give rides to passengers.

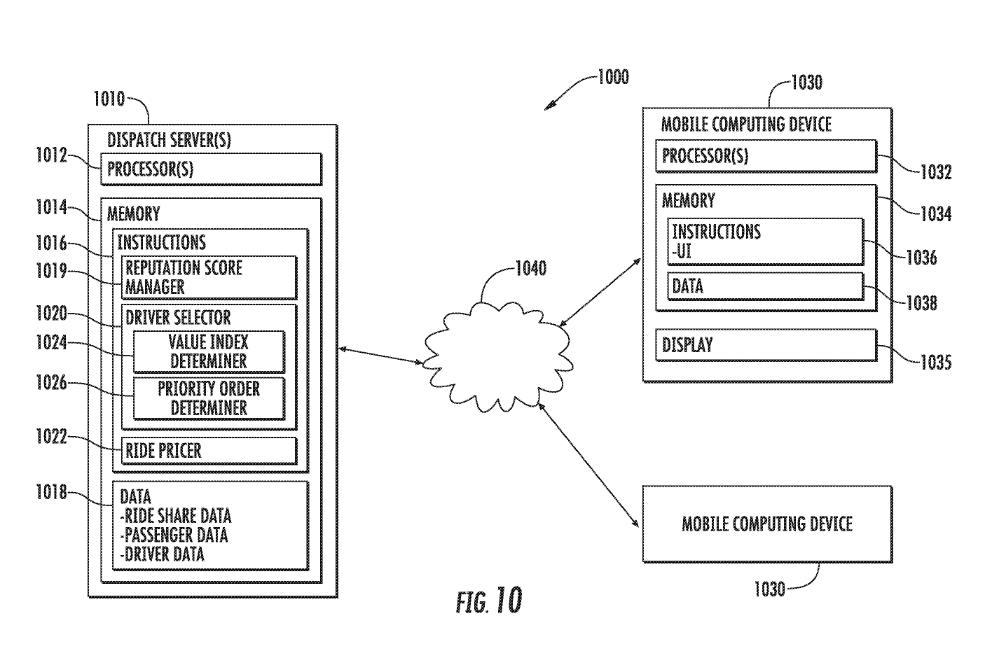

Particular example techniques that are implementable by the priority order determiner 126 to determine priority orders based at least in part on driver reputation scores are discussed in further detail in the Overview section above and also with reference to FIG. 9 below.

The offer(s) provided by the ride share platform 110 can include a compensation value for the matched driver. The compensation value can be determined by the ride pricer 122 using a pricing mechanism, such as a first-price proxy auction mechanism or an expected second-price auction pricing mechanism. For instance, the ride pricer 122 can be configured to generate estimated bids for each of the candidate drivers based at least in part on driver cost associated with each candidate driver. One of the estimated bids can be selected as the compensation value for the offer.

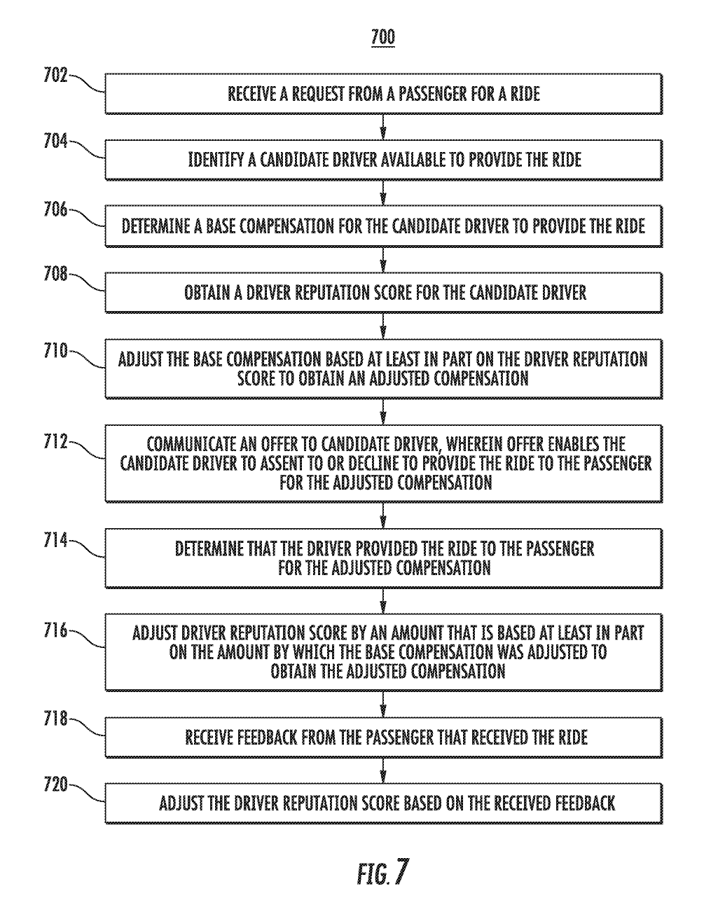

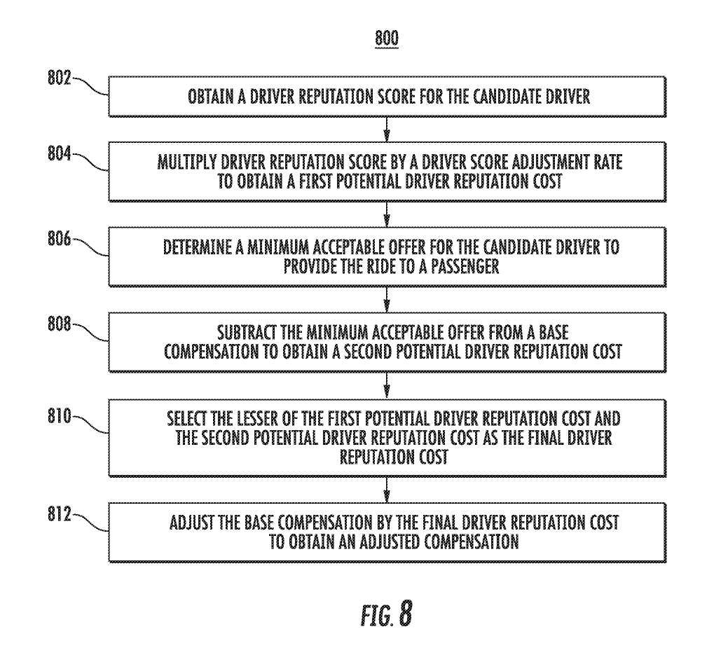

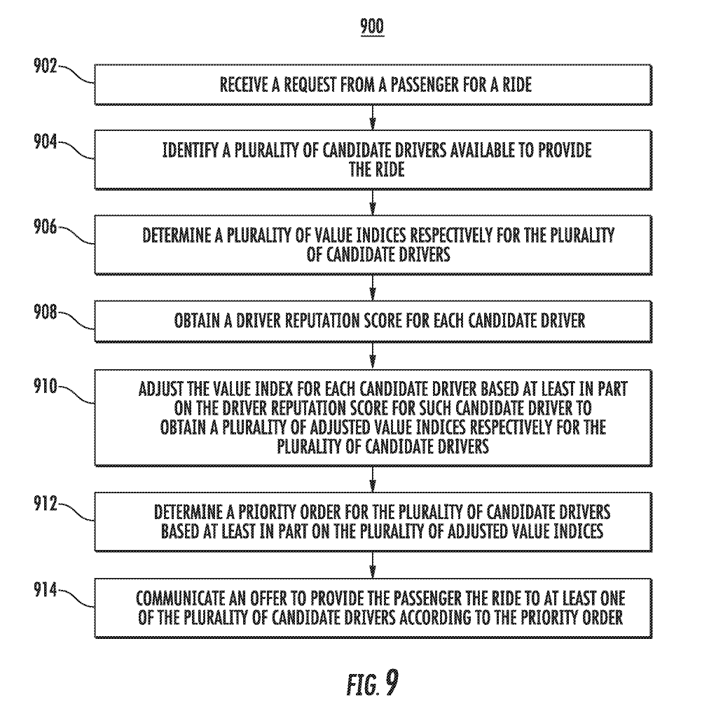

In some implementations, the ride pricer 122 can adjust (e.g., reduce) the compensation offered to a candidate driver based on the candidate driver's driver reputation score. For example, particular example techniques for adjusting driver compensation based on driver reputation score are discussed in further detail in the Overview section above and with reference to FIGS. 7 and 8 below.

The matched driver can accept or reject the offer, for example, by interacting with a user interface presented on a driver device 140. A candidate driver can also reject the offer, for example, by not responding to the offer within a specified period of time. For instance, the passenger as part of the request provided to the ride share platform 110 can specify a time by which the passenger needs to know whether a ride has been coordinated with a driver. A time limit can be set for a candidate driver to accept an offer based on the specified time. If a candidate driver does not respond within the time limit, the offer can be considered rejected.

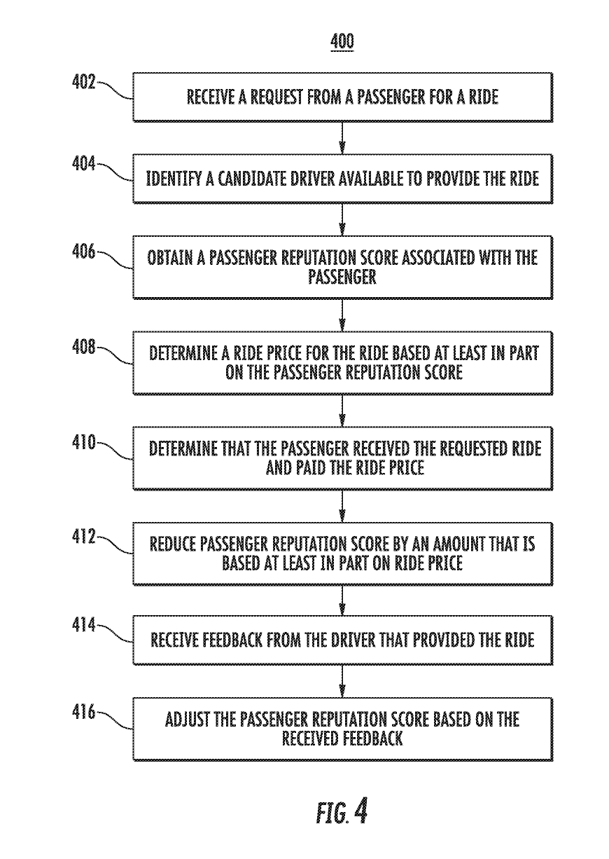

FIG. 3 depicts an example user interface 142 presented on a display of a driver device 140 for presenting an offer to a candidate driver according to example embodiments of the present disclosure. The user interface 142 can provide information 144 associated with the offer, such as name of the passenger, origin and destination of the passenger, pickup window, etc. The user interface 142 further includes a compensation value 146 for the candidate driver. The compensation value 146 can be less than or equal to the maximum bid specified by the passenger in the request. The compensation value 146 can be determined by the ride pricer 122 implemented by the ride share platform 110 and can be communicated to the driver device 140 for presentation in the user interface 142. The user interface 142 can further provide the candidate driver the ability to accept or reject the offer. A candidate driver can accept the offer, for example, by interacting with an accept interface element 147. A candidate driver can reject the offer, for example, by interacting with a reject interface element 148.

If a matched driver accepts the offer, a notification of acceptance can be communicated to the ride share platform 110 from the driver device 140. Upon receipt of the notification of acceptance, the ride share platform 110 can provide a notification to the passenger device 130 that a ride has been obtained. The passenger can confirm the ride, for example, by interacting with a user interface presented on the passenger device 130. Navigation information can then be communicated to the matched driver to coordinate the ride.

Once the ride has been coordinated between the passenger and the matched driver, the ride share platform 110 can arrange for providing compensation to the matched driver in accordance with the accepted offer. For instance, once the ride is completed, the ride share platform 110 can credit an account associated with the matched driver by an amount equal to the compensation value. The ride share platform 110 can also debit an account associated with the passenger by an amount equal to the compensation value.

According to other example aspects, the ride share platform 110 can apply penalties to the matched driver for various conditions. For example, if the matched driver arrives late in picking up the passenger, the ride share platform 110 can reduce the compensation value provided to the matched driver. As another example, the ride share platform 110 can reduce the compensation value provided to the matched driver if the matched driver receives a particularly negative review and/or if a driver rating associated with the matched driver falls below a threshold.

The ride share platform 110 can include various other features to enhance the user experience with the ride share platform 110. For instance, the ride share platform 110 can be configured to automatically alert the passenger if it is determined that the matched driver arrived to pick up the passenger early or if the candidate driver is running late. For instance, location data associated with the location of the matched driver can be obtained, for example, from a positioning system associated with the driver device 140. This location data can be analyzed to determine whether the matched driver has arrived early or is going to arrive late.

As an example, if the location data indicates that the matched driver is already located at the passenger origin to pick up the passenger, the ride share platform 110 can alert the passenger that the matched driver has arrived early. As another example, location data associated with the matched driver can be analyzed to determine the matched driver's estimated travel time to the passenger origin. The estimated travel time can be analyzed to determine whether the matched driver is going to be late. If it is determined that the matched driver is going to be late, a notification can be sent to the passenger. The passenger can then cancel the ride or make other appropriate arrangements.

According to yet other example aspects of the present disclosure, the ride share platform 110 can be configured to find a replacement ride for a passenger if a matched driver cancels or is going to arrive too late. For instance, if sufficient time is remaining before the passenger needs to be picked up, the ride share platform 110 can present offers to different candidate drivers to provide the passenger a ride. Alternatively, the ride share platform 110 can arrange for a driver service (e.g., a taxi service, limo service, or car service) to provide the passenger the ride.

### Example Methods for Implementing a Reputation System in a Ride Share Platform

FIG. 4 depicts a flow diagram of an example method 400 for operating a ride share network according to example embodiments of the present disclosure. The method 400 can be implemented by one or more computing devices, such as the ride share platform 110 of FIG. 1 and/or the dispatch servers 1010 discussed with reference to FIG. 10.

At 402, the ride share platform receives a request from a passenger for a ride. For instance, the ride can receive the request for the ride from a passenger device. The request can include information such as an origin, a destination, a pickup window of time when the passenger needs to be picked up, an arrival window of time when the passenger needs to arrive at the destination, the amount of time the passenger can wait before learning if a ride is available, a maximum bid, and other information.

At 404, the ride share platform identifies a candidate driver available to provide the ride. For example, the ride share platform can implement a driver selector to identify a candidate driver available to provide the passenger a ride from the origin to the destination specified in the request. The candidate driver can be identified using various factors, such as travel patterns associated with the driver, driver cost (e.g., cost of detour), maximum bid specified in the request, driver ratings, and other factors. If multiple candidate drivers are identified, then each candidate driver can be considered individually, for example, in series or in parallel or in some combination thereof.

At 406, the ride share platform obtains a passenger reputation score associated with the passenger. For example, the ride share platform can obtain the passenger reputation score from a network database. The passenger reputation score can be accessible based on a user identifier associated with the passenger.

At 408, the ride share platform determines a ride price for the ride based at least in part on the passenger reputation score. As one example, in some implementations, determining the ride price based at least in part on the passenger reputation score at 408 includes determining a base price for the ride. For example, the base price can be determined based at least in part on an estimate of the cost that a candidate driver would have to incur in order to give this passenger a ride (e.g., by making a detour from the driver's anticipated route).

In addition, determining the ride price based at least in part on the passenger reputation score at 408 can further include determining a passenger reputation cost based at least in part on the passenger reputation score associated with the passenger; and adjusting the base price by the passenger reputation cost to obtain an adjusted price for the ride. For example, the base price can be increased by the passenger reputation cost to obtain the adjusted price. The adjusted price can then be used as the ride price.

In some implementations, determining the passenger reputation cost based at least in part on the passenger reputation score includes multiplying the passenger reputation score by a passenger score adjustment rate. As one example, if a passenger has a positive passenger reputation score of d, a base price determined by the system for a ride requested by the passenger can be increased by a passenger reputation cost equal to rd, where r corresponds to the passenger score adjustment rate.

In addition, in some implementations, determining the ride price at 408 includes using a currency conversion value to convert the passenger reputation score into an amount of currency. In particular, reputation scores can be unitless or have their own unit of measurement. As such, the passenger reputation cost can be multiplied by a current conversion value so that the passenger reputation cost is expressed in units of currency. The ride share platform will typically maintain a currency conversion value for each different currency that is used in a location in which the ride share platform is available.

As one example, if the passenger reputation cost equals the amount rd=20; the passenger is located within the United States; and the United States Dollar has a currency conversion value of $0.05; then the passenger reputation cost can be expressed as $1 USD. Thus, in this example, the base price can be increased by $1 to obtain the ride price.

At 410, the ride share platform determines that the passenger received the requested ride and paid the ride price. For example, the ride share platform can analyze the location of the candidate driver and/or passenger to determine that the passenger received the requested ride. As another example, at 410, the ride share platform can receive signals from the passenger device and/or driver device which indicate that the passenger received the requested ride. For example, the passenger device and/or driver device can provide signals in response to user input indicating that the ride has been initiated and/or completed. The ride price can be debited from an account associated with the passenger.

At 412, the ride share platform reduces the passenger reputation score by an amount that is based at least in part on the ride price. As one example, at 412, the ride share platform can reduce the passenger reputation score by an amount that is based at least in part on the passenger reputation cost (e.g., an amount that is equal to the passenger reputation cost).

Thus, to continue the above provided example, the passenger was required to pay an amount rd more for this ride than the passenger would have had to pay in the absence of the passenger having a positive passenger reputation score. Thus, in such example scenario, at 412, the ride share platform can reduce the passenger reputation score by the amount rd.

Again, in some implementations, a currency conversion value can be used to return the passenger reputation score into reputation score units by performing an inverse conversion to the one described above.

At 414, the ride share platform receives feedback from the driver that provided the ride. As an example, after a ride takes place, the driver may be asked feedback questions that could influence the reputation of the passenger. As examples, these questions may include questions such as whether the ride took place; whether the passenger was polite and considerate; whether the experience was a good one; whether the driver would consider sharing a ride with the passenger again; and whether the passenger was on time. The driver can provide input at the driver device and transmit the feedback to the ride share platform.

At 416, the ride share platform adjusts the passenger reputation score based on the received feedback. In particular, the ride share platform can then impose reputation score penalties (e.g., increases in reputation score) and/or score rewards (e.g., decreases in reputation scores) on the basis of the answers to these feedback questions. For instance, a penalty can be imposed on a reputation score for not being polite and considerate or for a ride not taking place without a cancellation. Again, the amount by which the user's reputation score is adjusted can be proportional to the amount of economic harm that resulted from the indicated transgressions.

FIG. 5 depicts a flow diagram of an example method 500 for operating a ride share network according to example embodiments of the present disclosure. The method 500 can be implemented by one or more computing devices, such as the ride share platform 110 of FIG. 1 and/or the dispatch servers 1010 discussed with reference to FIG. 10.

At 502, the ride share platform determines that a passenger or a driver canceled a scheduled ride. For example, the ride share platform can receive signals from the driver device and/or passenger device which indicate that the driver and/or passenger has provided user input which cancels the ride (e.g., the passenger has selected to cancel the ride within the ride share application on their device). As another example, the ride share platform can receive feedback from either the driver or the passenger which indicates that the other user did not participate as planned.

At 504, the ride share platform determines an amount of time remaining until a scheduled time at which the scheduled ride was scheduled to occur. For example, if the ride is scheduled to occur at 2 PM and the time at which the cancellation occurred was 1 PM, then the amount of time remaining is 1 hour.

At 506, the ride share platform adjusts the passenger reputation score or the driver reputation score by a cancellation penalty value, where the cancellation penalty value is non-increasing in the amount of time remaining until the scheduled time. For example, the cancellation penalty value can be inversely proportional to the amount of time remaining until the scheduled time. As one example, a table or other data structure can provide bands of time which are respectively associated with different penalty magnitudes (e.g., amount of time remaining<5 minutes=100 point penalty; 5 minutes<amount of time remaining<1 hour=50 point penalty; etc.) As another example, the amount of time remaining can be input into a cancellation penalty formula to determine the magnitude of the cancellation penalty value. Driver and passenger cancellation penalty values can be equally scaled or differently scaled.

Thus, in general, whenever a user cancels a ride, the user's driver or passenger reputation score (whichever the case may be) can be adjusted (e.g., increased or otherwise penalized) by an amount that is non-increasing in an amount of time in advance this cancellation took place, thereby causing the penalty to be roughly proportional to an amount of economic harm caused by the cancellation.

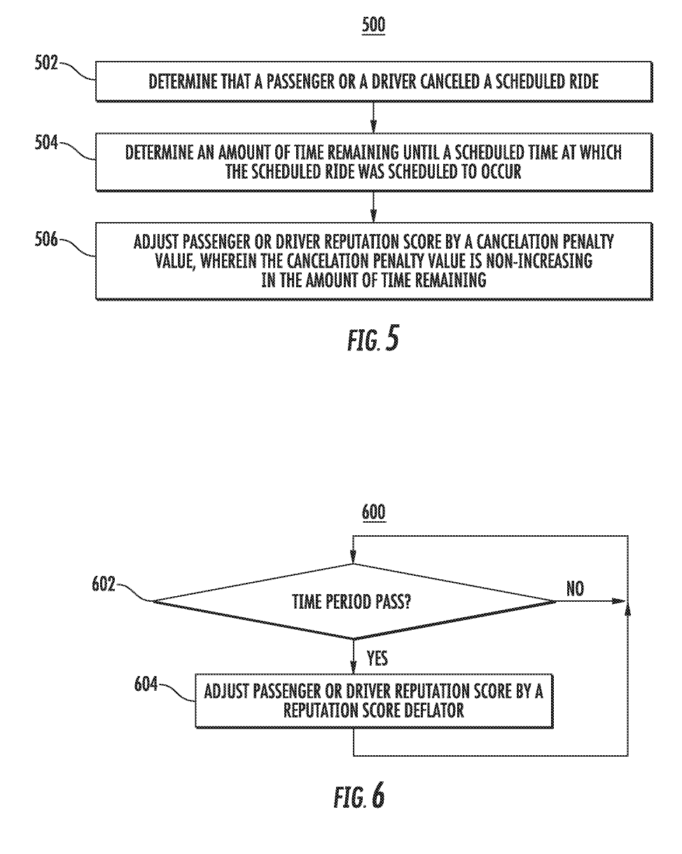

FIG. 6 depicts a flow diagram of an example method 600 for operating a ride share network according to example embodiments of the present disclosure. The method 600 can be implemented by one or more computing devices, such as the ride share platform 110 of FIG. 1 and/or the dispatch servers 1010 discussed with reference to FIG. 10.

At 602, the ride share platform determines whether a time period has passed. For example, the time period can be one hour, one day, etc. If the ride share platform determines at 602 that the time period has not passed, then the ride share platform returns to 602 again. In such fashion, the ride share platform waits for the time period to pass until another action is taken.

However, if the ride share platform determines at 602 that the time period has passed, then the ride share platform advances to 604. At 604, the ride share platform adjusts a passenger reputation score and/or a driver reputation score by a reputation score deflator. As one example, application of the reputation score deflator can cause the user's reputation score to be reduced by a certain percentage. As one particular example, the reputation score deflator can equal 99 percent, such that application of the reputation score deflator to a user's reputation score causes the user's reputation score to be reduced by 1 percent. In other implementations, the reputation score deflator can be a fixed amount, rather than a percentage.

After 604, the ride share platform returns to 602 and waits for an additional time period to pass. Thus, a user's driver and/or passenger reputation score can be decreased by a reputation score deflator for every fixed time period (e.g., hour, day, etc.) where the user does not incur a penalty, even if the user did not use the ride share platform during such time period. Use of a reputation score deflator in such fashion means that even a user with a very poor reputation (e.g., a very large reputation score) is eventually able to reduce her reputation score after an extended period of good behavior.

FIG. 7 depicts a flow diagram of an example method 700 for operating a ride share network according to example embodiments of the present disclosure. The method 700 can be implemented by one or more computing devices, such as the ride share platform 110 of FIG. 1 and/or the dispatch servers 1010 discussed with reference to FIG. 10.

At 702, the ride share platform receives a request from a passenger for a ride. For instance, the ride can receive the request for the ride from a passenger device. The request can include information such as an origin, a destination, a pickup window of time when the passenger needs to be picked up, an arrival window of time when the passenger needs to arrive at the destination, the amount of time the passenger can wait before learning if a ride is available, a maximum bid, and other information.

At 704, the ride share platform identifies a candidate driver available to provide the ride. For example, the ride share platform can implement a driver selector to identify a candidate driver available to provide the passenger a ride from the origin to the destination specified in the request. The candidate driver can be identified using various factors, such as travel patterns associated with the driver, driver cost (e.g., cost of detour), maximum bid specified in the request, driver ratings, and other factors. If multiple candidate drivers are identified, then each candidate driver can be considered individually, for example, in series or in parallel or in some combination thereof.

At 706, the ride share platform determines a base compensation for the candidate driver to provide the ride. For example, the base compensation can be determined based at least in part on an estimate of the cost that a candidate driver would have to incur in order to give this passenger a ride (e.g., by making a detour from the driver's anticipated route).

At 708, the ride share platform obtains a driver reputation score for the candidate driver. For example, the ride share platform can obtain the driver reputation score from a network database. The driver reputation score can be accessible based on a user identifier associated with the candidate driver.

At 710, the ride share platform adjusts the base compensation based at least in part on the driver reputation score to obtain an adjusted compensation. As one example, in some implementations, adjusting the base compensation based at least in part on the driver reputation score at 710 can include determining a driver reputation cost based at least in part on the driver reputation score associated with the driver; and adjusting the base compensation based at least in part on the driver reputation cost. For example, the driver reputation cost can be subtracted from the base compensation to obtain the adjusted compensation.

Furthermore, in some implementations, determining the driver reputation cost based at least in part on the driver reputation score associated with the driver can include multiplying the driver reputation score by a driver score adjustment rate to obtain the driver reputation cost. As one example, if a driver has a positive driver reputation score of d, a base compensation determined by the system for a ride requested by the passenger can be reduced by a driver reputation cost equal to rd, where r corresponds to the driver score adjustment rate. The driver score adjustment rate can be equal or not equal to the passenger score adjustment rate discussed above.

In addition, in some implementations, adjusting the base compensation based at least in part on the driver reputation score at 710 includes using a currency conversion value to convert the driver reputation score into an amount of currency. In particular, reputation scores can be unitless or have their own unit of measurement. As such, the driver reputation cost can be multiplied by a current conversion value so that the driver reputation cost is expressed in units of currency. The ride share platform will typically maintain a currency conversion value for each different currency that is used in a location in which the ride share platform is available.

As one example, if the driver reputation cost equals the amount rd=20; the driver is located within the United States; and the United States Dollar has a currency conversion value of $0.05; then the driver reputation cost can be expressed as $1 USD. Thus, in this example, the base compensation can be reduced by $1 to obtain the adjusted compensation.

FIG. 8 depicts a flow diagram of another example method 800 for adjusting a base compensation based at least in part on a driver reputation score. The method 800 can be implemented by one or more computing devices, such as the ride share platform 110 of FIG. 1 and/or the dispatch servers 1010 discussed with reference to FIG. 10.

At 802, the ride share platform obtains a driver reputation score for a candidate driver. For example, the ride share platform can obtain the driver reputation score from a network database. The driver reputation score can be accessible based on a user identifier associated with the candidate driver.

At 804, the ride share platform multiplies the driver reputation score by a driver score adjustment rate to obtain a first potential driver reputation cost. For example, the first potential driver reputation cost can be determined as described above with reference to 710.

At 806, the ride share platform determines a minimum acceptable offer for the candidate driver to provide the ride to the passenger. Generally, the minimum acceptable offer can be an estimate of the cost that a candidate driver would have to incur in order to give this passenger a ride or some fraction thereof (e.g., 90%).

At 808, the ride share platform subtracts the minimum acceptable offer from the base compensation to obtain a second potential driver reputation cost.

At 810, the ride share platform selects the lesser of the first potential driver reputation cost and the second potential driver reputation cost as the final driver reputation cost.

At 812, the ride share platform adjusts the base compensation by the final driver reputation cost to obtain the adjusted compensation. For example, the final driver reputation cost can be subtracted from the base compensation to obtain the adjusted compensation. Again, a currency conversion value can be used to convert the final driver reputation cost into units of currency.

As one example application of method 800, if a base compensation p denotes the compensation that the ride share platform would offer the driver if the driver had a zero or negative driver reputation score and c denotes a minimum amount that would be an acceptable offer to make to the driver, then the ride share platform can offer the driver compensation equal to the larger of c and p-rd (e.g., by selecting the lesser of rd and p-c as the final driver reputation cost).

However, in such instances, the ride share platform will only reduce the driver's reputation score by p-c if the driver is compensated the amount c for the ride. Likewise, the ride share platform will reduce the driver's reputation score by rd only if the driver is compensated the amount p-rd for providing the ride. Thus, the amount by which the driver reputation score is reduced is equal to the amount by which the driver's compensation was reduced from the base compensation.

Referring again to FIG. 7, after obtaining the adjusted compensation at 710, then at 712, the ride share platform communicates an offer to the candidate driver. The offer enables the candidate driver to assent to or decline to provide the ride to the passenger for the adjusted compensation.

At 714, the ride share platform determines that the driver provided the ride to the passenger for the adjusted compensation. For example, the ride share platform can analyze the location of the candidate driver and/or passenger to determine that the passenger received the requested ride. As another example, at 714, the ride share platform can receive signals from the passenger device and/or driver device which indicate that the passenger received the requested ride. For example, the passenger device and/or driver device can provide signals in response to user input indicating that the ride has been initiated and/or completed. An account associated with the driver can be credited by an amount equal to the adjusted compensation.

At 716, the ride share platform adjusts the driver reputation score by an amount that is based at least in part on the amount by which the base compensation was adjusted to obtain the adjusted compensation. As one example, at 716, the ride share platform can reduce the driver reputation score by an amount that is equal to the driver reputation cost.

At 718, the ride share platform receives feedback from the passenger that received the ride. As an example, after a ride takes place, the passenger may be asked feedback questions that could influence the reputation of the driver. As examples, these questions may include questions such as whether the ride took place; whether the driver was polite and considerate; whether the inside of the car was clean; whether the experience was a good one; whether the passenger would consider sharing a ride with this driver again; and whether the driver was on time.

At 720, the ride share platform adjusts the driver reputation score based on the received feedback. For instance, a penalty can be imposed on a reputation score for not being polite and considerate or for a ride not taking place without a cancellation. As another example, a user's driver reputation score might be penalized if the passenger indicates that the inside of the driver's car was not reasonably clean or if the driver was late to the pick up the passenger.

Again, the amount by which the user's reputation score is adjusted can be proportional to the amount of economic harm that resulted from the indicated transgressions. For instance, a user's driver reputation score can be adjusted by a relatively smaller amount for being two minutes late while the user's driver reputation score can be adjusted by a relatively larger amount for being ten minutes late. Likewise, a user's driver reputation score can be adjusted by a relatively smaller amount if the passenger feedback indicates that the driver's vehicle was relatively unclean (e.g., rated 3 out of 5), while the user's driver reputation score can be adjusted by a relatively larger amount if the passenger feedback indicates that the driver's vehicle was very unclean (e.g., rated 1 out of 5 stars).

FIG. 9 depicts a flow diagram of an example method 900 for operating a ride share network according to example embodiments of the present disclosure. The method 900 can be implemented by one or more computing devices, such as the ride share platform 110 of FIG. 1 and/or the dispatch servers 1010 discussed with reference to FIG. 10.

At 902, the ride share platform receives a request from a passenger for a ride. For instance, the ride can receive the request for the ride from a passenger device. The request can include information such as an origin, a destination, a pickup window of time when the passenger needs to be picked up, an arrival window of time when the passenger needs to arrive at the destination, the amount of time the passenger can wait before learning if a ride is available, a maximum bid, and other information.

At 904, the ride share platform identifies a plurality of candidate drivers available to provide the ride. For example, the ride share platform can implement a driver selector to identify candidate drivers available to provide the passenger a ride from the origin to the destination specified in the request. The candidate drivers can be identified using various factors, such as travel patterns associated with the driver, driver cost (e.g., cost of detour), maximum bid specified in the request, driver ratings, and other factors.

At 906, the ride share platform determines a plurality of value indices respectively for the plurality of candidate drivers. The value index determined for a candidate driver can be indicative of an amount of economic surplus that would be generated if the candidate driver provided the requested ride to the passenger. The value index for each driver can be determined based on various factors such as, for example, a driver cost and a passenger benefit. For example, the value index for a candidate driver can equal the passenger benefit minus the driver cost.

At 908, the ride share platform obtains a driver reputation score for each of the plurality of candidate drivers. For example, the ride share platform can obtain the driver reputation score for each candidate driver from a network database. The driver reputation score for each candidate driver can be accessible based on a user identifier associated with such candidate driver.

At 910, the ride share platform adjusts the value index for each candidate driver based at least in part on the driver reputation score for such candidate driver to obtain a plurality of adjusted value indices respectively for the plurality of candidate drivers. As an example, for each candidate driver that has a positive driver reputation score, the value index for such candidate driver can be reduced by an amount equal to rd, where r equals a driver reputation score adjustment rate and d equals such candidate driver's driver reputation score.

At 912, the ride share platform determines a priority order for the plurality of candidate drivers based at least in part on the plurality of adjusted value indices. For example, the candidate drivers that has the larger adjusted value index can be ranked first and so forth.

At 914, the ride share platform communicates an offer to provide the passenger the ride to at least one of the plurality of candidate drivers according to the priority order. For instance, the ride share platform can communicate an offer to a driver device for presentation to a candidate driver. The offer can include a determined compensation value in addition to other information, such as passenger origin, passenger destination, passenger info, pickup window, etc.

The ride share platform can determine whether there has been an acceptance the offer. For instance, the ride share platform can determine whether it has received an acceptance of the offer from a driver device. The driver can accept the offer, for example, by interacting with a suitable user interface presented on the driver device. If an acceptance of the offer has been received, the ride can be confirmed with the passenger. If an acceptance of the offer is not received (e.g., the offer is rejected or a predetermined period of time without acceptance expires), then the ride share network can communicate an offer to the next candidate driver in the priority order.

### Example Computing Systems

FIG. 10 depicts a computing system 1000 that can be used to implement the methods and systems according to example aspects of the present disclosure. The system 1000 can be implemented using a client-server architecture that includes one or more dispatch server computing devices 1010 that communicate with one or more mobile computing devices 1030 over a network 1040. The system 1000 can be implemented using other suitable architectures, such as a single computing device.

The system 1000 includes one or more dispatch server computing devices 1010, which may be, for example, one or more web servers. The dispatch server 1010 can have one or more processors 1012 and memory 1014. The dispatch server 1010 can also include a network interface used to communicate with one or more mobile computing devices 1030 over the network 1040. The network interface can include any suitable components for interfacing with one more networks, including for example, transmitters, receivers, ports, controllers, antennas, or other suitable components.

The one or more processors 1012 can include any suitable processing device, such as a microprocessor, microcontroller, integrated circuit, application-specific integrated circuit, logic device, or other suitable processing device. The memory 1014 can include one or more computer-readable media, including, but not limited to, non-transitory computer-readable media, RAM, ROM, hard drives, flash drives, or other memory devices.

The memory 1014 can store information accessible by the one or more processors 1012, including computer-readable instructions 1016 that can be executed by the one or more processors 1012. The instructions 1016 can be any set of instructions that when executed by the one or more processors 1012, cause the one or more processors 1012 to perform operations. For instance, the instructions 1016 can be executed by the one or more processors 1012 to implement a reputation score manager 1019, a driver selector 1020, and a ride pricer 1022 of a ride share platform. The driver selector 1020 can include a value index determiner 1024 and a priority order determiner 1026.

Memory 1014 can also include data 1018 that can be retrieved, manipulated, created, or stored by the one or more processors 1012. The data 1018 can include, for example, ride share data, passenger data (e.g., passenger reputation scores), driver data (e.g., driver reputation scores), geographic data, navigation routes, etc. The data 1018 can be stored in one or more databases. The one or more databases can be connected to the dispatch server 1010 by a high bandwidth LAN or WAN, or can also be connected to server 1010 through network 1040. The one or more databases can be split up so that they are located in multiple locales.

The dispatch server 1010 can exchange data with one or more mobile computing devices 1030 over the network 1040. Although two mobile computing devices 1030 are illustrated in FIG. 10, any number of mobile computing devices 1030 can be connected to the dispatch server 1010 over the network 1040. Each of the mobile computing devices 1030 can be any suitable type of computing device, such as a special purpose computer, laptop, smartphone, tablet, wearable computing device, navigational system embedded within a vehicle, an autonomous vehicle computing system, PDA, or other suitable computing device.

Similar to the dispatch server 1010, a mobile computing device 1030 can include one or more processor(s) 1032 and a memory 1034. The one or more processor(s) 1032 can include one or more central processing units (CPUs) and/or other processing devices, microprocessors, controllers, etc. The memory 1034 can include one or more computer-readable media and can store information accessible by the one or more processors 1032, including instructions 1036 that can be executed by the one or more processors 1032 and data 1038. For instance, the memory 1034 can store instructions 1036 for presenting a graphical user interface of a mobile ride share application.

The mobile computing device 1030 of FIG. 10 can include various input/output devices for providing and receiving information from a user, such as a touch screen, touch pad, data entry keys, speakers, and/or a microphone suitable for voice recognition. For instance, the mobile computing device 1030 can have a display 1035 for presenting geographic imagery of a geographic area to a user.

The mobile computing device 1030 can further include a positioning system. The positioning system can be any device or circuitry for determining the position of a mobile computing device. For example, the positioning device can determine actual or relative position by using a satellite navigation positioning system (e.g., a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

The mobile computing device 1030 can also include a network interface used to communicate with one or more remote computing devices (e.g., server 1010) over the network 1040. The network interface can include any suitable components for interfacing with one more networks, including for example, transmitters, receivers, ports, controllers, antennas, or other suitable components.

The network 1040 can be any type of communications network, such as a local area network (e.g., intranet), wide area network (e.g., Internet), cellular network, or some combination thereof. The network 1040 can also include a direct connection between a mobile computing device 1030 and the dispatch server 1010. In general, communication between the dispatch server 1010 and a mobile computing device 1030 can be carried via network interface using any type of wired and/or wireless connection, using a variety of communication protocols (e.g., TCP/IP, HTTP, SMTP, FTP), encodings or formats (e.g., HTML, XML), and/or protection schemes (e.g., VPN, secure HTTP, SSL).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations, and/or additions to the present subject matter as would be readily apparent to one of ordinary skill in the art. For instance, features illustrated or described as part of one embodiment can be used with another embodiment to yield a still further embodiment. Thus, the present disclosure includes such alterations, variations, and equivalents.

In addition, although FIGS. 4-9 respectively depict steps performed in a particular order for purposes of illustration and discussion, the methods of the present disclosure are not limited to the particularly illustrated order or arrangement. The various steps of the methods 400, 500, 600, 700, 800, and 900 can be omitted, rearranged, combined, and/or adapted in various ways without deviating from the scope of the present disclosure.

What is claimed is:

1. A computer-implemented method for operating a ride share network, the method comprising:
receiving, by one or more computing devices, a request from a passenger for a ride from an origin to a destination;
identifying, by the one or more computing devices, a candidate driver available to provide the ride to the passenger;
obtaining, by the one or more computing devices, a passenger reputation score associated with the passenger; and
determining, by the one or more computing devices, a ride price for the ride from the origin to the destination based at least in part on the passenger reputation score.

2. The method of claim 1, wherein determining, by the one or more computing devices, the ride price for the ride from the origin to the destination based at least in part on the passenger reputation score comprises:
determining, by the one or more computing devices, a base price for the ride from the origin to the destination;
determining, by the one or more computing devices, a passenger reputation cost based at least in part on the passenger reputation score associated with the passenger; and
adjusting, by the one or more computing devices, the base price by the passenger reputation cost to obtain an adjusted price for the ride, wherein the adjusted price is used as the ride price.

3. The method of claim 2, wherein determining, by the one or more computing devices, the passenger reputation cost based at least in part on the passenger reputation score comprises multiplying, by the one or more computing devices, the passenger reputation score by a passenger score adjustment rate.

4. The method of claim 2, further comprising:
determining, by the one or more computing devices, that the user paid the ride price to receive the ride from the candidate driver; and
in response to determining that the user paid the ride price to receive the ride from the candidate driver, adjusting, by the one or more computing devices, the passenger reputation score by the passenger reputation cost.

5. The method of claim 1, further comprising:
determining, by the one or more computing devices, that the passenger canceled a scheduled ride; and
in response to determining that the passenger canceled a scheduled ride, adjusting, by the one or more computing devices, the passenger reputation score based on the cancellation of the scheduled ride.

6. The method of claim 5, wherein adjusting, by the one or more computing devices, the passenger reputation score based on the cancellation of the scheduled ride comprises adjusting, by the one or more computing devices, the passenger reputation score by a cancellation penalty value, wherein a magnitude of the cancellation penalty value is non-increasing in an amount of time remaining, when the scheduled ride was canceled, until a scheduled time at which the scheduled ride was scheduled to occur.

7. The method of claim 1, further comprising:
receiving, by the one or more computing devices, data that describes feedback provided by the candidate driver after the candidate driver provided the ride to the passenger; and
adjusting, by the one or more computing devices, the passenger reputation score based at least in part on feedback provided by the candidate driver.

8. The method of claim 1, further comprising:
periodically adjusting, by the one or more computing devices, the passenger reputation score by a passenger reputation score deflator.

9. A computer system to operate a ride share network, the computer system comprising:
one or more dispatch server computing devices communicatively coupleable to a plurality of mobile computing devices respectively operated by one or more candidate drivers and one or more passengers, the one or more dispatch server computing devices comprising one or more processors and one or more non-transitory computer-readable media that store instructions, that, when executed by the one or more processors, cause the one or more dispatch server computing devices to:
receive a request from a passenger for a ride from an origin to a destination;
identify a candidate driver available to provide the ride to the passenger;
determine a base compensation for the candidate driver to provide the ride to the passenger;
obtain a driver reputation score associated with the candidate driver;
adjust the base compensation based at least in part on the driver reputation score to obtain an adjusted compensation; and
communicate an offer to a mobile computing device operated by the candidate driver, wherein the offer enables the candidate driver to assent to or decline to provide the ride to the passenger for the adjusted compensation.

10. The computer system of claim 9, wherein the instructions which cause the one or more dispatch server computing devices to adjust the base compensation based at least in part on the driver reputation score to obtain an adjusted compensation cause the one or more dispatch server computing devices to:
determine a driver reputation cost based at least in part on the driver reputation score associated with the driver; and
adjust the base compensation based at least in part on the driver reputation cost.

11. The computer system of claim 10, wherein the instructions which cause the one or more dispatch server computing devices to determine the driver reputation cost based at least in part on the driver reputation score associated with the driver cause the one or more dispatch server computing devices to multiply the driver reputation score by a driver score adjustment rate to obtain the driver reputation cost.

12. The computer system of claim 10, wherein the instructions which cause the one or more dispatch server computing devices to determine the driver reputation cost based at least in part on the driver reputation score associated with the driver cause the one or more dispatch server computing devices to:
multiply the driver reputation score by a driver score adjustment rate to obtain a first potential driver reputation cost;
determine a minimum acceptable offer for the candidate driver to provide the ride to the passenger;
subtract the minimum acceptable offer from the base compensation to obtain a second potential driver reputation cost; and
select the lesser of the first potential driver reputation cost and the second potential driver reputation cost as the driver reputation cost.

13. The computer system of claim 10, wherein execution of the instructions further causes the one or more dispatch server devices to:
determine that the candidate driver provided the ride to the passenger; and
in response to determining that the candidate driver provided the ride to the passenger, adjust the driver reputation score by the driver reputation cost.

14. The computer system of claim 9, wherein execution of the instructions further causes the one or more dispatch server devices to:
determine that the candidate driver canceled a scheduled ride; and
in response to determining that the candidate driver canceled a scheduled ride, adjust the driver reputation score based on the cancellation of the scheduled ride.

15. The computer system of claim 14, wherein the driver reputation score is adjusted by a cancellation penalty value, and wherein a magnitude of the cancellation penalty value is non-increasing in an amount of time remaining, when the scheduled ride was canceled, until a scheduled time at which the scheduled ride was scheduled to occur.

16. The computer system of claim 9, wherein execution of the instructions further causes the one or more dispatch server devices to:
receive data that describes feedback provided by the passenger after the candidate driver provided the ride to the passenger; and
adjust the driver reputation score based at least in part on feedback provided by the passenger.

17. The computer system of claim 9, wherein execution of the instructions further causes the one or more dispatch server devices to:
periodically adjust the driver reputation score by a driver reputation score deflator.

18. A computing system, comprising:
one or more processors; and
one or more computer-readable media, the one or more computer-readable media storing computer-readable instructions that when executed by the one or more processors cause the one or more processors to:
receive a request from a passenger for a ride from an origin to a destination;
identify a plurality of candidate drivers for providing the ride to the passenger;
determine a plurality of value indices respectively for the plurality of candidate drivers, the plurality of value indices including a first value index for a first candidate driver of the plurality of candidate drivers;
obtain a first driver reputation score for the first candidate driver of the plurality of candidate drivers;
adjust the first value index determined for the first candidate driver based at least in part on the first driver reputation score to obtain an adjusted first value index;
determine a priority order for the plurality of candidate drivers based at least in part on the plurality of value indices including the adjusted first value index; and
communicate an offer to provide the passenger a ride to at least one of the plurality of candidate drivers according to the priority order, the offer comprising a compensation value for providing the ride to the passenger.

19. The computing system of claim 18, wherein the offer is communicated to the first candidate driver, and wherein the compensation value is based on the first value index but not the adjusted first value index.

20. The computing system of claim 18, wherein execution of the instructions further causes the one or more processors to:
determine that the first candidate driver provided the ride to the passenger; and
in response to determining that the first candidate driver provided the ride to the passenger, adjust the first driver reputation score by an amount by which the first value index was adjusted to obtain the adjusted first value index.
